(19) United States
(12) Patent Application Publication
(10) Pub. No.: US 2005/0195834 A1
(43) Pub. Date: Sep. 8, 2005

(54) Load distribution system

(76) Inventor: Shunsuke Kikuchi, Kawasaki (JP)

Correspondence Address: KATTEN MUCHIN ROSENMAN LLP, 575 MADISON AVENUE, NEW YORK, NY, 10022-2585, US

(21) Appl. No.: 11/100,208

(22) Filed: Apr. 6, 2005

Related U.S. Application Data
(63) Continuation of application No. PCT/JP03/04143, filed on Mar. 31, 2003.

(51) Int. Cl. H04L 12/56

(52) U.S. Cl. 370/396

(57) ABSTRACT

A load distribution system performing load measurement and load distribution control efficiently at a high speed and capable of improving the quality of communication and reliability. A transmission byte count acquisition block acquires the number of transmission bytes on a destination address basis from a frame. A transmission byte count storage block stores the accumulated number of transmission bytes in a transmission byte count table. A transmission byte count report block transfers the number of transmission bytes stored in the transmission byte count table, at regular intervals. An overloaded-unit detection block compares the transferred number of transmission bytes and the number of transmission bytes that can be received by a load distribution unit and detects any overloaded load distribution unit. An assignment adjustment block adjusts the traffic assignment by reducing the volume of an assignment to any load distribution unit determined to be overloaded.

This application is a continuing application, filed under 35 U.S.C. §111 (a), of International Application PCT/JP2003/004143, filed on Mar. 31, 2003.

### BACKGROUND OF THE INVENTION

1. Field of the Invention

The present invention relates to load distribution systems, and particularly to a load distribution system for distributing traffic load.

2. Description of the Related Art

Recent information networks are built in a wide variety of forms. Improvements in quality of communication and quality of service are needed for increased transmission capacities. As the internal load of a network has been rapidly increasing under these circumstances, load distribution control has been increasing in importance. The network load must be efficiently distributed so that the network can stand a heavy load. Load distribution for current high-speed large-capacity networks requires an efficient load measurement function and a high-speed load distribution function.

Conventional load distribution technologies are based on a load measured by counting the number of file access requests to be processed or by counting the number of transactions underway and the number of transaction processes remaining in the EPU system.

A technology disclosed in Japanese Unexamined Patent Publication No. Hei-6-332782 (paragraph numbers 0010 to 0017 and FIG. 1) performs management in units of files in order to count the number of file access requests to be processed. However, this file management can cause a bottleneck in high-speed load distribution. It has been difficult to enhance the speed of load distribution.

A technology disclosed in Japanese Unexamined Patent Application Publication No. 2002-278945 (paragraph numbers 0012 to 0027 and FIG. 1) must check transaction statuses and process statuses in order to count the number of transactions underway and the number of transaction processes remaining in the EPU system. However, the processing for monitoring the transaction statuses and the process statuses can cause a bottleneck in high-speed load distribution. This also indicates difficulty in speeding up load distribution.

### SUMMARY OF THE INVENTION

In view of the foregoing, it is an object of the present invention to provide a load distribution system which can improve the quality of communication and reliability by performing load measurement and load distribution control efficiently at a high speed.

To accomplish the above object, according to the present invention, there is provided a load distribution system for distributing traffic load. This load distribution system includes the following elements: a plurality of load distribution units for receiving a traffic assignment and distributing the load, a pre-assignment unit disposed in a stage preceding the plurality of load distribution units, and a management unit. The pre-assignment unit includes a transmission byte count acquisition block for acquiring the number of transmission bytes from a frame, a transmission byte count storage block for storing the number of transmission bytes accumulated on a destination address basis in a transmission byte count table, and a transmission byte count report block for reporting the number of transmission bytes stored in the transmission byte count table, at regular intervals. The management unit includes an overloaded-unit detection block for detecting any overloaded load distribution unit by comparing the reported number of transmission bytes and the number of bytes that can be received by each of the plurality of load distribution units and an assignment adjustment block for adjusting the traffic assignment by reducing the volume of traffic assignment to any load distribution unit determined to be overloaded.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the concept of a load distribution system according to the present invention.

FIG. 2 shows an overview of the elimination of a traffic imbalance.

FIG. 3 shows the configuration of a client-server communication system.

FIG. 4 shows a detailed configuration of the load distribution system.

FIG. 5 shows the contents of information specified in an assignment destination table.

FIG. 6 shows an operation sequence of determining a frame assignment destination.

FIG. 7 shows an overview of transmission byte count measurement.

FIG. 8 shows an operation sequence of the transmission byte count measurement.

FIG. 9 shows an operation sequence of reporting the result of the transmission byte count measurement.

FIG. 10 shows an operation sequence of determining the contents of a reassignment.

FIG. 11 illustrates the processing for detecting an overloaded unit.

FIG. 12 shows an operation sequence of transferring the contents of a reassignment.

FIG. 13 shows an operation sequence of setting up an assignment destination table.

FIG. 14 shows how a reassignment is specified in the assignment destination table.

FIG. 15 shows a separate assignment destination table provided for each user.

FIG. 16 shows an overview of the transmission byte count measurement.

FIG. 17 shows how the total number of transmission bytes of each load distribution unit is calculated.

FIG. 18 shows an operation of detecting a user sending the greatest number of frames.

FIG. 19 shows an interchange count storage table.

### DESCRIPTION OF THE PREFERRED EMBODIMENTS

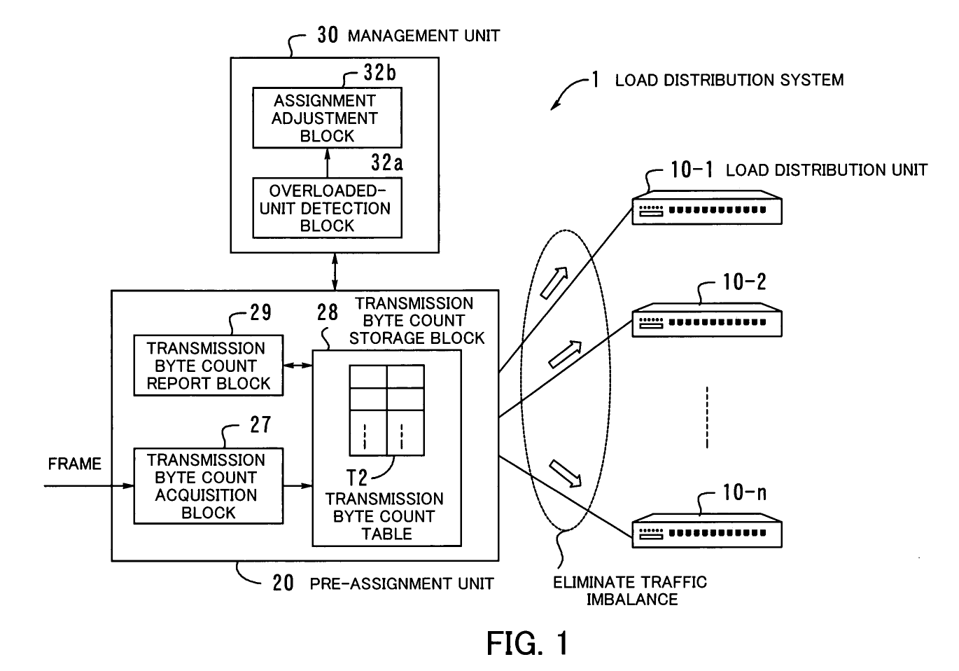

Embodiments of the present invention will be described with reference to the drawings. FIG. 1 shows the concept of a load distribution system according to the present invention. A load distribution system 1 for distributing the traffic load of a network includes a plurality of load distribution units 10-1 to 10-n, a pre-assignment unit 20, and a management unit 30.

With the plurality of load distribution units, the system according to the present invention can handle such a high volume of traffic that cannot be handled by a single load distribution unit. The pre-assignment unit 20 and the management unit 30 are disposed in a stage preceding the load distribution units and divide the transmission traffic among the load distribution units 10-1 to 10-n. The functions of the management unit 30 may be included in the pre-assignment unit 20.

The load distribution units 10-1 to 10-n receive a traffic assignment which is adjusted by the management unit 30 and is sent from the pre-assignment unit 20, and perform load distribution.

The pre-assignment unit 20 includes a transmission byte count acquisition block 27, a transmission byte count table T2, and a transmission byte count storage block 28. The transmission byte count acquisition block 27 acquires a destination address (the address of the load distribution unit to be assigned) and a frame length from a frame (or a packet). The frame length is the number of transmission bytes (the number of bytes in the transmission frame) for the destination address.

The number of transmission bytes (frame length) acquired by the transmission byte count acquisition block 27 is accumulated on a destination address basis, and the transmission byte count storage block 28 stores the accumulated number of transmission bytes in the transmission byte count table T2. The information stored in the transmission byte count table T2 indicates the amount of traffic that has been assigned to each of the load distribution units 10-1 to 10-n. A transmission byte count report block 29 notifies the management unit 30 of the transmission byte count stored in the transmission byte count table T2 at regular intervals.

The management unit 30 includes an overloaded-unit detection block 32a and an assignment adjustment block 32b. The overloaded-unit detection block 32a detects any overloaded load distribution unit by comparing the informed transmission byte count and the predetermined number of bytes that can be received by the load distribution units 10-1 to 10-n.

The assignment adjustment block 32b reduces the amount of assignment to any load distribution unit determined to be overloaded and dynamically adjusts the volume of traffic assignment so that the traffic will not be concentrated on a particular load distribution unit.

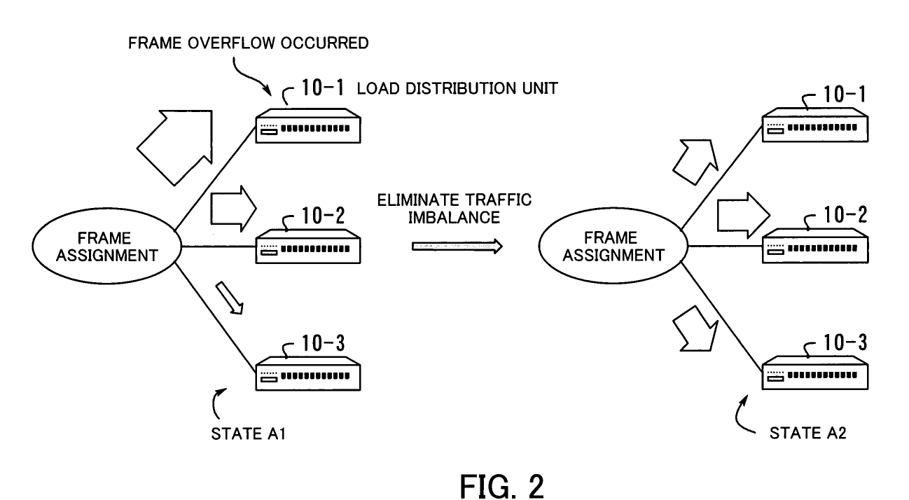

According to the present invention, a traffic imbalance among the load distribution units 10-1 to 10-n is eliminated. FIG. 2 shows an overview of the elimination of a traffic imbalance. The left state A1 shows that the frames assigned to the load distribution units 10-1 to 10-3 are unbalanced. In the load distribution unit 10-1 which receives the greatest number of frames, for instance, the frame reception buffer may overflow and some frames may be discarded. The discarding of frames will lower the quality of user service.

The right state A2 shows that a traffic imbalance has been eliminated. The assignment function according to the present function eliminates a traffic imbalance, on the basis of the amount of transmission data or the number of transmission bytes measured after an actual frame assignment. The function prevents frames from being concentrated on a particular load distribution unit. Accordingly, no frames will be discarded, and the quality of service will not be reduced.

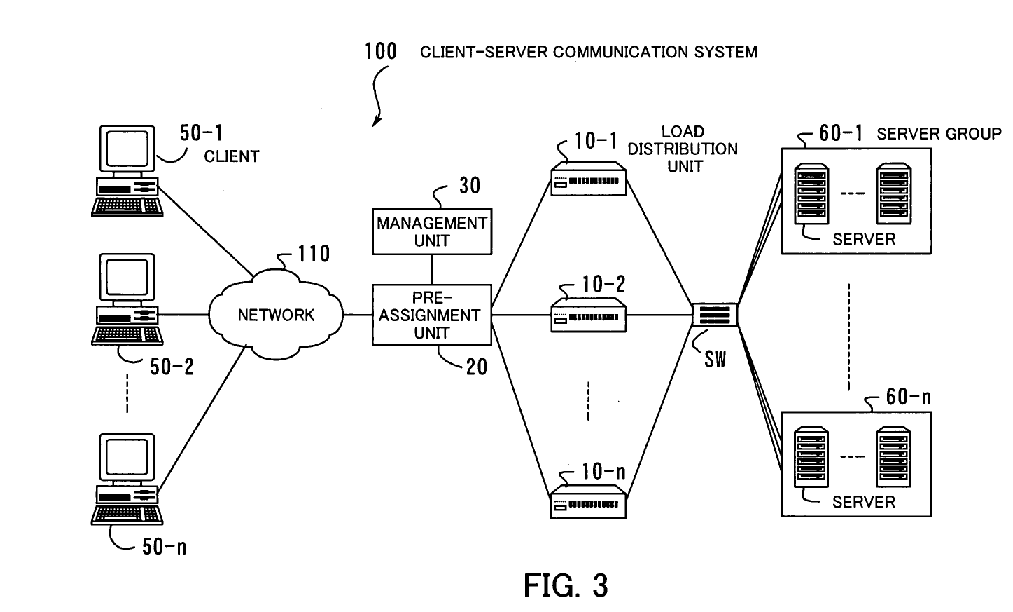

One application example using the load distribution system 1 according to the present invention in a client-server communication system will next be described. FIG. 3 shows the configuration of the client-server communication system. A client-server communication system 100 includes a plurality of clients 50-1 to 50-n, a network 110, a pre-assignment unit 20, a management unit 30, a plurality of load distribution units 10-1 to 10-n, a switch SW, and a plurality of server groups 60-1 to 60-n. Each of the server groups 60-1 to 60-n includes a plurality of servers.

The clients 50-1 to 50-n and the pre-assignment unit 20 are connected to the network 110. The management unit 30 and the load distribution units 10-1 to 10-n are connected to the pre-assignment unit 20. The load distribution units 10-1 to 10-n are also connected to the switch SW, and the switch SW is connected to the server groups 60-1 to 60-n.

In the client-server communication system 100, a great number of requests from the clients 50-1 to 50-n are accepted by a plurality of identical servers for performing identical processing. In a stage preceding the server groups 60-1 and 60-n, the load distribution units 10-1 to 10-n are connected via the switch SW.

A great volume of traffic is handled in this way: The requests sent from the clients 50-1 to 50-n via the network 110 are assigned among the load distribution units 10-1 to 10-n by the pre-assignment unit 20 and the management unit 30; and the load distribution units 10-1 to 10-n assign the requests to appropriate servers.

The load distribution units 10-1 to 10-n analyze the contents of a request sent from a client, select an appropriate server accordingly, and transfer the request to the server with the original destination of the request rewritten to the address of the server.

The design concepts and features of a transmission byte count measurement function of the pre-assignment unit 20 and of an assignment control function of the management unit 30 according to the present invention will next be described.

In the load distribution units 10-1 to 10-n (generically designated as a load distribution unit 10), frames (packets) should not be discarded because of an overflow of a frame reception buffer. Conventionally, the status of the frame reception buffer of the load distribution unit 10 is monitored, and a frame assignment block having a frame assignment function in the pre-assignment unit is notified of the status. Then, the amount of transmission to the load distribution unit is reduced. Alternatively, the buffer is enlarged.

In the former method of reducing the amount of traffic in accordance with the information sent from the load distribution unit 10 to the frame assignment block, the frame assignment block must perform a complicated function, making it impossible to achieve a desired speed. The latter method of enlarging the buffer cannot solve the problem fundamentally if input to the buffer is much greater than output from the buffer.

Another method of preventing the overflow of frames is to control traffic assignment to the load distribution unit 10 by means of hashing based on the source address of an input frame and transferring the frame to the load distribution unit corresponding to a hash value. (Hashing is a computation method of generating a fixed-length pseudorandom number from a given source (data) . The pseudorandom number is referred to as a hash value.)

If the source addresses are uniformly distributed in the input traffic, there will be no imbalance in traffic. Actually, the source addresses may not be uniformly distributed. A client having a certain source address may intensively generate traffic, and a certain group of clients may have source addresses corresponding to one certain hash value.

With that kind of unbalanced input traffic, balanced traffic assignment is impossible. A non-uniform distribution of source addresses in the input traffic will lead to traffic assignment biased toward a particular load distribution unit, as in the state A1 shown in FIG. 2. As a result, an excessive volume of traffic is concentrated on a particular load distribution unit. The frame reception buffer of the load distribution unit overflows, and the load distribution unit discards frames.

The transmission byte count measurement function according to the present invention implements a part of traffic assignment to the load distribution unit 10. The load on the load distribution unit 10 is measured in terms of the volume of transmission traffic.

The load distribution unit 10 is configured to handle all received frames by the CPU. In other words, the load distribution unit 10 is configured not to receive frames exceeding the processing capability of the CPU. The load status of the load distribution unit 10 or the degree of reduction in service level can be known by checking whether a frame can be received or whether the reception buffer has room. Overflow from the reception buffer can be detected by checking whether the amount of transmission traffic or the number of transmitted bytes measured exceeds the reception capability of the load distribution unit.

The transmission byte count measurement processing including a sequence of transmission byte count acquisition, accumulation, and notification, according to the present invention, does not require feedback from the assignment destination and does not include conditional processing. The simple processing can be implemented at a high speed by hardware, without the intervention of complicated software.

The assignment control function will next be described. The pre-assignment unit 20 measures the number of transmission bytes and sends the measured count to the management unit 30 as a frame. The management unit 30 determines the contents of a reassignment or of the elimination of a traffic imbalance, in accordance with the number of transmission bytes measured by the pre-assignment unit 20. The point is that the transmission byte count measurement function and the assignment control function are independent of each other.

The transmission byte count measurement function must be performed at a high speed as described above. The assignment control function is a judgment function which is generally complicated and need not be performed at a high speed. The assignment destination should be reviewed not continuously but at regular intervals. Accordingly, the two functions can be independent of each other if they can work in liaison with each other.

Interfacing between the two functions is easier than interfacing between the pre-assignment unit 20 and the load distribution units 10-1 to 10-n. The latter requires communication among the pre-assignment unit 20 and the load distribution units 10-1 to 10-n. It is also required to consolidate information received from the load distribution units 10-1 to 10-n. The transmission byte count measurement function of the pre-assignment unit 20 and the assignment control function of the management unit 30 are in a one-to-one relationship and do not require consolidation of information and other processing.

The management unit 30 checks the measured transmission byte count to see whether the number of bytes that can be processed by the load distribution unit 10 is exceeded, and determines whether the frame reception buffer of the load distribution unit 10 overflows.

If the load distribution unit is determined to be overloaded, the contents of an assignment destination table, which will be described later, are corrected to reduce the amount of assignment to the load distribution unit. More specifically, the load distribution unit determined to be overloaded is replaced by another load distribution unit in an item for the corresponding hash value. The contents of the reassignment are transferred from the management unit 30 to the pre-assignment unit 20 and incorporated in the assignment destination table.

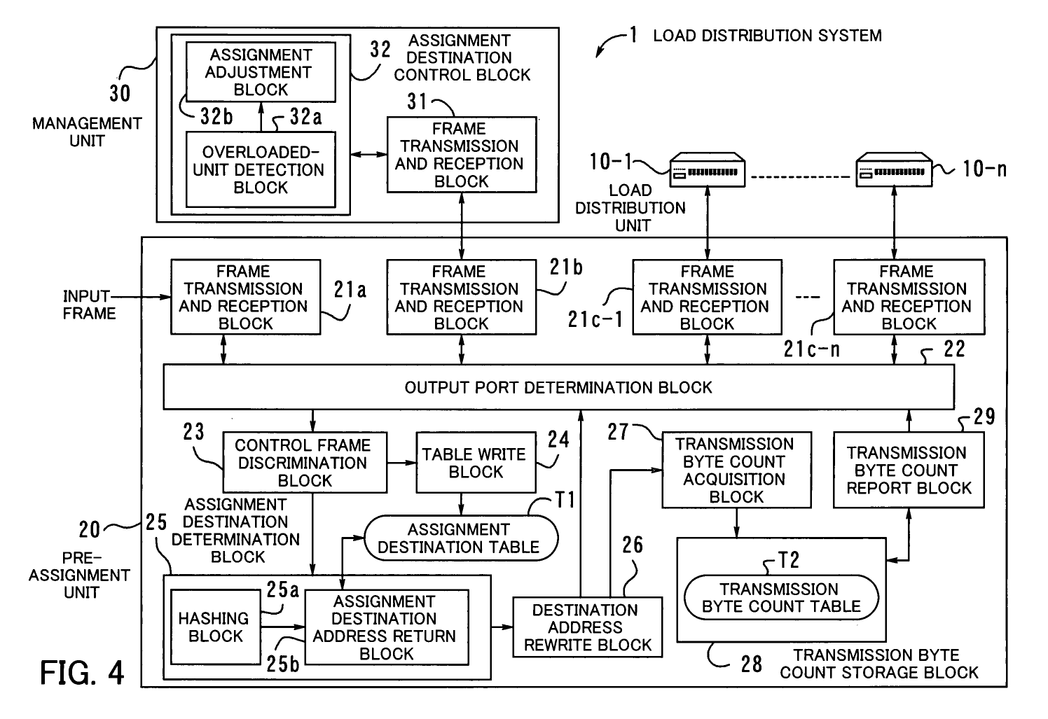

The configuration and operation of the pre-assignment unit 20 and the management unit 30 will next be described in further detail. FIG. 4 shows a detailed configuration of the load distribution system 1. A frame transmission and reception block 21a in the pre-assignment unit 20 has a frame transmission and reception function for interfacing communication with the client, and receives an input frame. A frame transmission and reception block 21b has a frame transmission and reception function for interfacing communication with the management unit 30.

The frame transmission and reception blocks 21c-1 to 21c-n have frame transmission and reception functions for interfacing communication with the load distribution units 10-1 to 10-n respectively. An output port determination block 22 has a function to send certain information to the corresponding block in the pre-assignment unit 20 or to receive information from the corresponding block in the pre-assignment unit 20.

A control frame discrimination block 23 judges whether an input frame received through the frame transmission and reception block 21a and the output port determination block 22 should be transferred to an assignment destination determination block 25 as a frame to be assigned to the load distribution units 10-1 to 10-n or to a table write block 24 as a control frame to the pre-assignment unit 20. The judgment is made on the basis of a flag included in the data portion of the frame or the like.

The table write block 24 takes data from the control frame sent from the management unit 30 and writes the data in the assignment destination table T1, which is used to assign a load distribution unit to a hash value.

The output values (hash values) of the hash function are not directly assigned to the load distribution units 10-1 to 10-n in a one-to-one relationship. A table corresponding to each output value of the hash function is provided to specify which load distribution unit is assigned. If the hash function has eight output values while three load distribution units are provided, the lack of the table will produce a ⅝ probability that there is no assignment destination.

The assignment destination determination block 25 includes a hashing block 25a and an assignment destination address return block 25b, and has a function to determine an assignment destination from an input frame. The hashing block 25a applies a hash function to the source address of an input frame and obtains a hash value. A hash function with eight output values, sixteen output values, and others can be used. The number of output values must be greater than the number of load distribution units that can be assigned by the pre-assignment unit 20.

The assignment destination address return block 25b searches through the assignment destination table T1 for the hash value, obtains the address of the corresponding load distribution unit (assignment destination address), and returns the address to a destination address rewrite block 26. The destination address rewrite block 26 rewrites the original destination address of the input frame to the address of the load distribution unit received from the assignment destination address return block 25b.

A transmission byte count acquisition block 27 obtains the number of transmission bytes on a destination address basis by acquiring a destination address and a frame length from a frame sent from the destination address rewrite block 26. A transmission byte count storage block 28 stores the number of transmission bytes in the transmission byte count table T2. A transmission byte count report block 29 transfers the accumulated number of transmission bytes to the output port determination block 22 at regular intervals. The number of transmission bytes is transferred through the output port determination block 22 and the frame transmission and reception block 21b to the management unit 30.

A frame transmission and reception block 31 in the management unit 30 has a frame transmission and reception function for interfacing communication with the pre-assignment unit 20. An assignment destination control block 32 includes an overloaded-unit detection block 32a and an assignment adjustment block 32b. The assignment destination control block 32 detects a traffic imbalance and corrects the contents of the assignment destination table T1 accordingly. The corrected contents are transferred to the pre-assignment unit 20 as a frame.

The overloaded-unit detection block 32a detects any overloaded load distribution unit, by comparing the transmission byte count received from the pre-assignment unit 20 and the number of bytes that can be received by the load distribution units 10-1 to 10-n to check whether the volume of traffic that can be handled by the load distribution unit predetermined in the management unit is exceeded.

The assignment adjustment block 32b corrects the assignment destination table T1 so that the assignment to the load distribution unit detected by the overloaded-unit detection block 32a is reduced and is reassigned to another load distribution unit with the least transmission traffic.

The operation of the system according to the present invention will next be described in further detail. The operation can be broadly divided into the determination of a frame assignment destination, transmission byte count measurement, the notification of the measurement result, the determination of the contents of reassignment, the transfer of the contents of reassignment, and the setup of the assignment destination table T1. Each part of the operation will next be described.

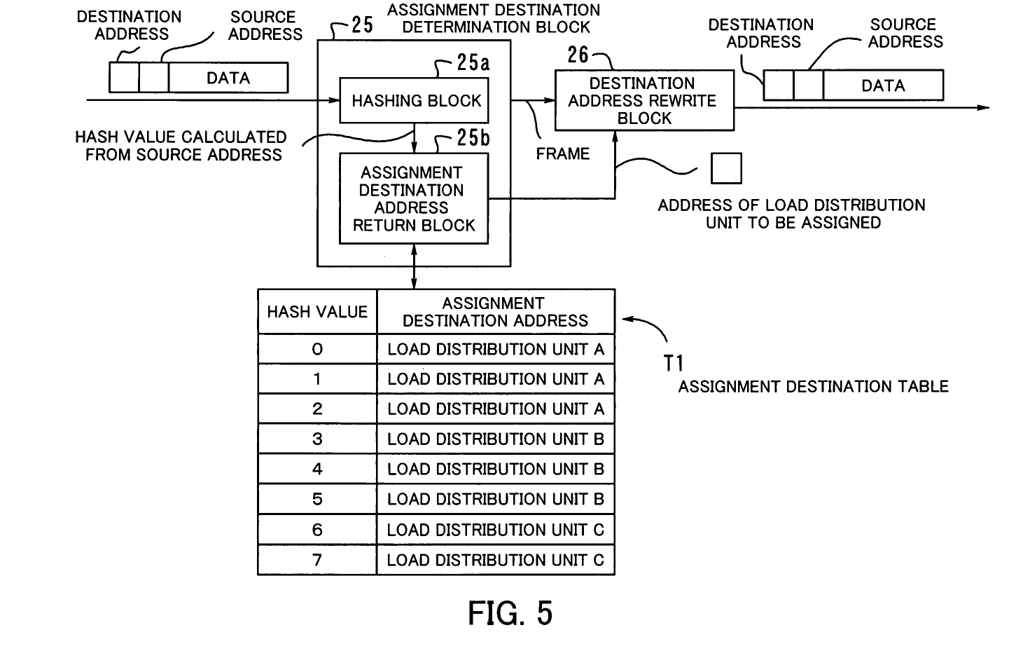

Determination of a frame assignment destination: Input traffic assigned to three load distribution units A, B, and C is specified by a ratio. FIG. 5 shows the contents of information specified in the assignment destination table T1. An example of load assignment to three load distribution units A, B, and C by the pre-assignment unit 20 is shown in the figure. It is supposed that an input traffic of 80 Mbps is assigned to the load distribution units A, B, and C at a ratio of 3:3:2.

The hashing block 25a applies an octal hash function to the source address of an input frame, obtains a hash value, and returns the value to the assignment destination address return block 25b.

The assignment destination address return block 25b searches through the assignment destination table T1 for the received hash value, obtains the address of the corresponding destination load distribution unit, and sends the address to the destination address rewrite block 26.

The destination address rewrite block 26 rewrites the original destination address of the input frame to the address of the load distribution unit to be assigned. Now, 30-Mbps traffic, 30-Mbps traffic, and 20-Mbps traffic are expected to be assigned to the load distribution units A, B, and C, respectively.

The ratio can be specified as desired, and the ratio can be 4:2:2 instead of 3:3:2, for instance. However, the total of the numbers (3+3+2 or 4+2+2) must be the number of hash values, 8. The ratio is actually specified by the management unit 30.

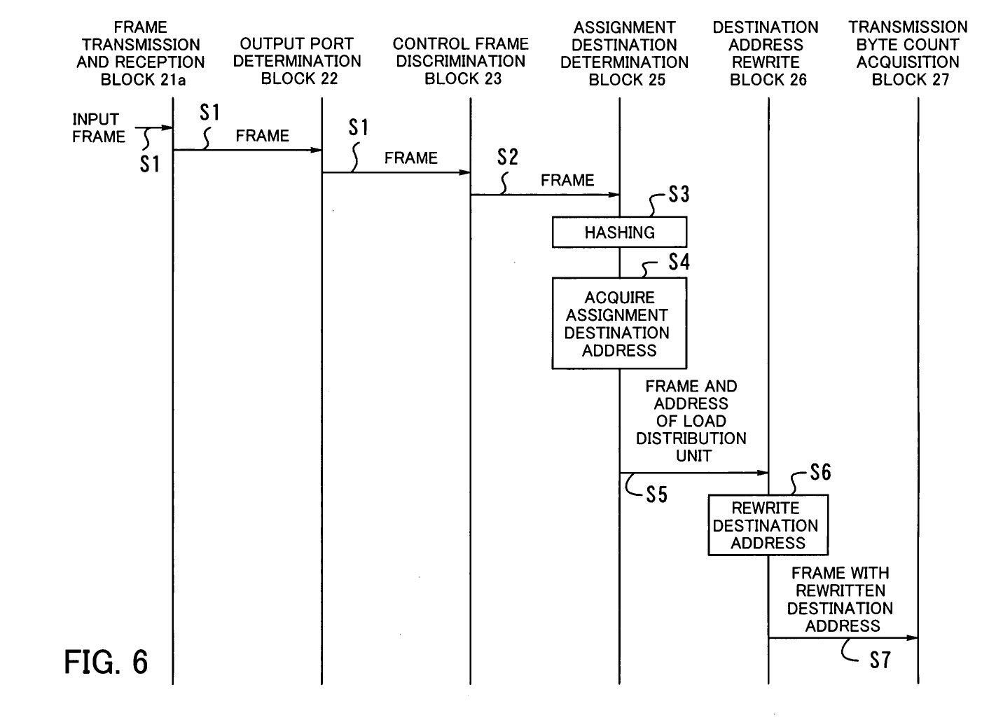

FIG. 6 shows an operation sequence of determining a frame assignment destination.

Step S1: The frame transmission and reception block 21a receives a frame from a client. The output port determination block 22 checks the destination address of the received frame. If the address of the pre-assignment unit 20 is included, the frame is transferred to the control frame discrimination block 23.

Step S2: The control frame discrimination block 23 checks the data portion of the frame to see whether the contents should be included in the assignment destination table or whether the frame is a general data frame. A data frame is transferred to the assignment destination determination block 25.

Step S3: When the assignment destination determination block 25 receives the frame, the hashing block 25a extracts the source address, applies an octal hash function to the address, and transfers the result of operation to the assignment destination address return block 25b.

Step S4: The assignment destination address return block 25b obtains the address of a load distribution unit from the corresponding assignment destination table T1, in accordance with the hash value output from the hash function.

Step S5: The assignment destination determination block 25 transfers the frame and the address of the load distribution unit to the destination address rewrite block 26.

Step S6: The destination address rewrite block 26 rewrites the destination address of the frame to the address of the load distribution unit.

Step S7: The destination address rewrite block 26 transfers the frame with the rewritten destination address to the transmission byte count acquisition block 27.

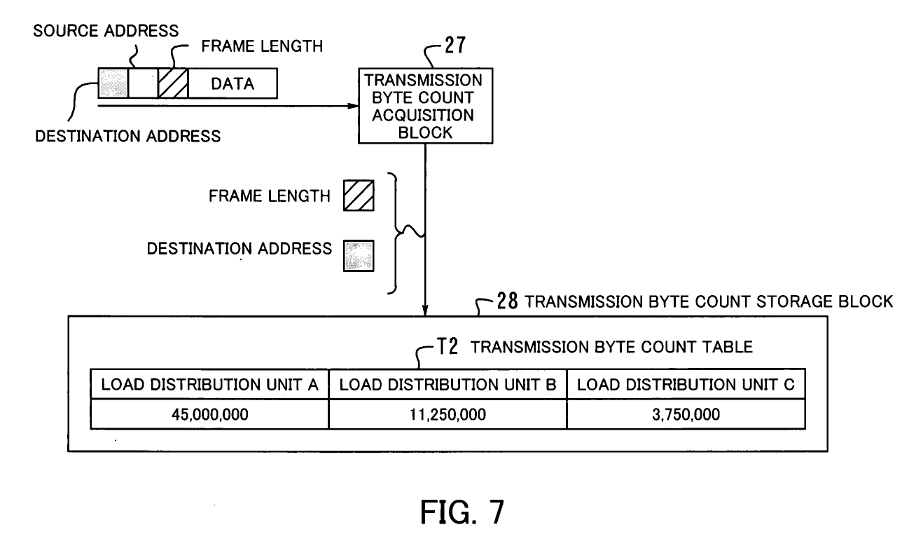

Transmission byte count measurement: FIG. 7 shows an overview of the transmission byte count measurement. The transmission byte count acquisition block 27 obtains a frame length from the frame with the rewritten destination address. The transmission byte count storage block 28 adds the frame length to the item corresponding to the destination address stored in the transmission byte count table T2.

In the example shown in the figure, if the frame length is 64 bytes and if the destination address is the address of the load distribution unit A, 64 is added to 45,000,000. The frame length corresponding to each load distribution unit is accumulated in this way to obtain the total number of transmission bytes.

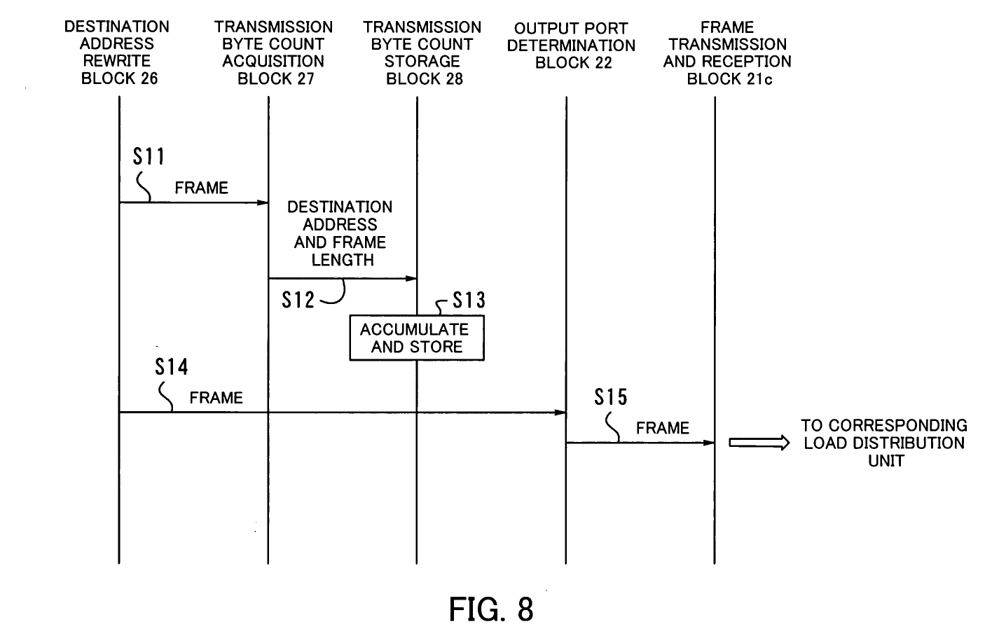

FIG. 8 shows an operation sequence of the transmission byte count measurement. Steps S11 to S13 pertain to the transmission byte count measurement, and steps S14 and S15 pertain to frame assignment to a load distribution unit.

Step S11: The destination address rewrite block 26 transfers the frame with a rewritten destination address to the transmission byte count acquisition block 27.

Step S12: The transmission byte count acquisition block 27 transfers a destination address and a frame length obtained from the received frame to the transmission byte count storage block 28.

Step S13: The transmission byte count storage block 28 adds the frame length to the item corresponding to the destination address in the transmission byte count table T2.

Step S14: The destination address rewrite block 26 transfers the frame with the rewritten destination address to the output port determination block 22.

Step S15: The output port determination block 22 transfers the frame to the frame transmission and reception block 21c corresponding to the destination address, and the frame transmission and reception block 21c sends the frame to the corresponding load distribution unit. If the input frame is a data frame, steps S1 to S15 are repeated.

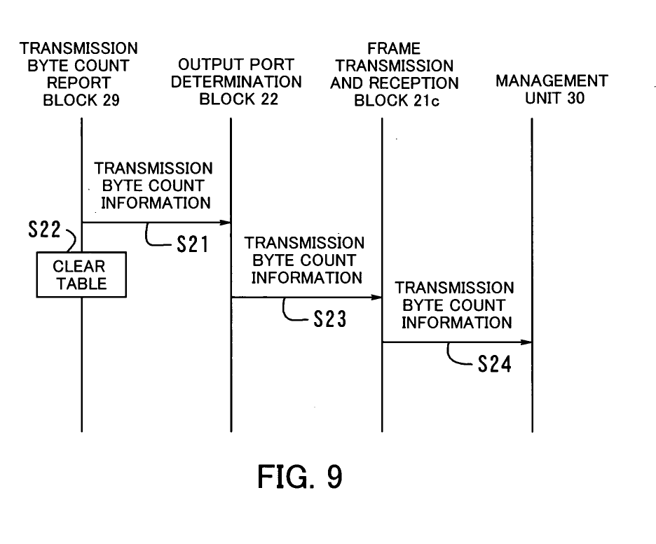

Notification of the measurement result: The transmission byte count report block 29 puts the contents of the transmission byte count table T2 into a frame and sends the frame to the management unit 30 at regular intervals, such as once per minute or once in five minutes. FIG. 9 shows an operation sequence of reporting the result of the transmission byte count measurement.

Step S21: The transmission byte count report block 29 transfers the contents (transmission byte count information) of the transmission byte count table T2 to the output port determination block 22 as a frame of which destination address is the management unit 30.

Step S22: The transmission byte count report block 29 clears the contents of the transmission byte count table T2 while the information is transferred in step S21.

Step S23: The output port determination block 22 transfers the received frame to the frame transmission and reception block 21b so as to transfer it to the management unit 30.

Step S24: The frame transmission and reception block 21b sends the frame of the transmission byte count information to the management unit 30. The frame transmission and reception block 31 in the management unit 30 receives and transfers the frame to the assignment destination control block 32.

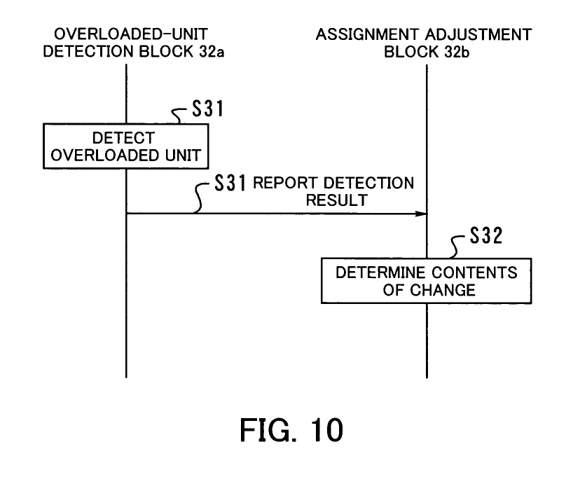

Determination of the contents of reassignment: The assignment destination control block 32 of the management unit 30 detects any overloaded load distribution unit and adjusts the volume of traffic assignment to the unit. FIG. 10 shows an operation sequence of determining the contents of a reassignment.

Step S31: The overloaded-unit detection block 32a compares the informed transmission byte count with the predetermined number of bytes that can be received by the load distribution unit. If the load distribution unit is determined to be overloaded, the information of the unit is transferred to the assignment adjustment block 32b.

Step S32: The assignment adjustment block 32b generates information for reassigning the assignment to the overloaded unit to another unit with the smallest transmission byte count, for instance, in the assignment destination table T1.

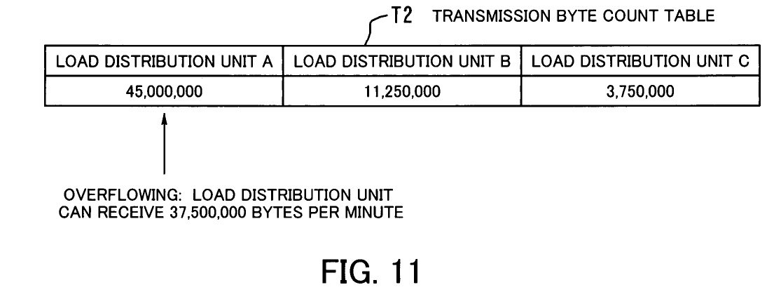

FIG. 11 illustrates the processing for detecting an overloaded unit. The transmission byte count table T2 contains the transmission byte counts corresponding to the load distribution units A, B, and C. The transmission byte count of the load distribution unit A is 45,000,000 (45 megabytes). The transmission byte count of the load distribution unit B is 11,250,000 (11.25 megabytes). The transmission byte count of the load distribution unit C is 3,750,000 (3.75 megabytes).

Suppose that the load distribution unit has a reception capability of 50 Mbps. 50 Mbps divided by 8 equals 6.25 megabytes per sec., which equals 37.5 megabytes per minute. The transmission byte count of the load distribution unit A exceeds the level of 37.5 megabytes per minute, and the load distribution unit A is detected as an overloaded unit.

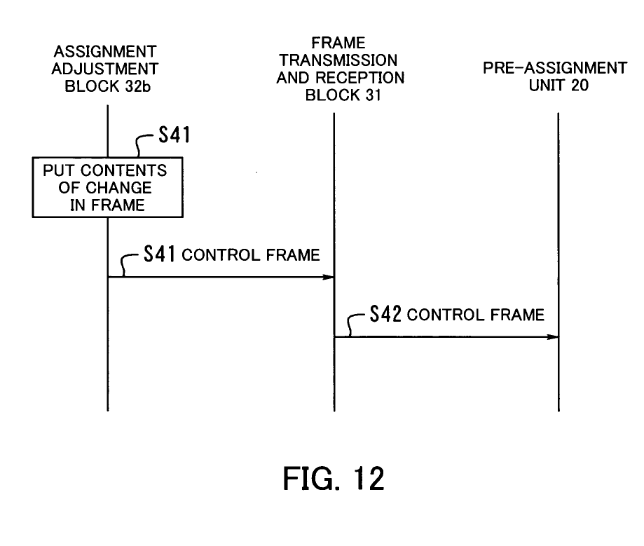

Transfer of the contents of reassignment: FIG. 12 shows an operation sequence of transferring the contents of a reassignment.

Step S41: The assignment adjustment block 32b puts the contents of a reassignment into a frame. The destination address of the frame is the pre-assignment unit 20, and the data portion includes the contents of the reassignment. A flag indicating that the frame is a control frame containing the contents of a reassignment is set. The frame is transferred to the frame transmission and reception block 31.

Step S42: The frame transmission and reception block 31 transfers the control frame including the contents of the reassignment to the pre-assignment unit 20.

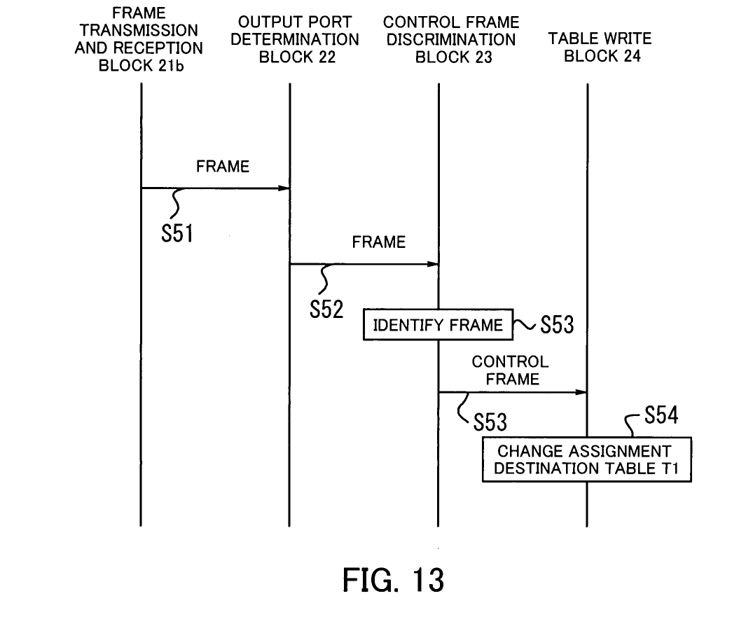

Setup of the assignment destination table T1: FIG. 13 shows an operation sequence of setting up the assignment destination table T1.

Step S51: The frame transmission and reception block 21b in the pre-assignment unit 20 receives and transfers the frame to the output port determination block 22.

Step S52: The output port determination block 22 checks the destination address of the received frame. Because the destination address is the address of the pre-assignment unit 20, the frame is transferred to the control frame discrimination block 23.

Step S53: The control frame discrimination block 23 checks the data portion of the frame and checks whether the data should be incorporated in the assignment destination table T1 or whether the frame should be handled as a general data frame. The frame sent in this example is recognized as a control frame and is transferred to the table write block 24.

Step S54: The table write block 24 takes data from the control frame and overwrites the assignment destination table T1 with the data.

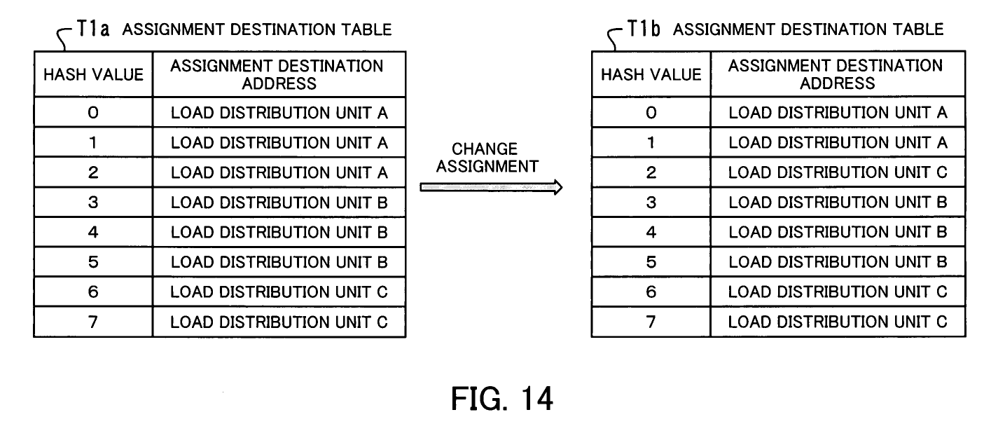

FIG. 14 shows how a reassignment is specified in the assignment destination table T1. In an assignment destination table T1a, hash values 0 to 2 correspond to the load distribution unit A, hash values 3 to 5 correspond to the load distribution unit B, and hash values 6 and 7 correspond to the load distribution unit C. If the load distribution unit A is determined to be overloaded, a reassignment is made to the load distribution unit C with the least volume of traffic, for instance.

In an assignment destination table T1b after the reassignment, hash values 0 and 1 correspond to the load distribution unit A, hash values 3 to 5 correspond to the load distribution unit B, and hash values 2, 6, and 7 correspond to the load distribution unit C.

A modified embodiment of the present invention will next be described. A load distribution system 1a of the modified embodiment has a multi-user function.

Recently, many networks are built, maintained, or managed not by individual companies but by a subcontracting specialized company, referred to as an Internet data center (IDC). The IDC provides a network including a plurality of logically independent network structures and rents the network to a plurality of user companies.

In such a network type, a volume of traffic that would not cause a problem for a single user could cause interference among multiple users.

The system according to the modified embodiment of the present invention can measure load and can perform load distribution control efficiently at a high speed in the multi-user environment. Interference among multiple users can be avoided, and the quality of communication and reliability can be improved. The load distribution system 1a of the modified embodiment basically has the same configuration as the load distribution system 1 shown in FIG. 4. The difference in configuration and operation between the two systems will now be described.

A transmission byte count measurement function of a pre-assignment unit 20 acquires a destination address, a frame length, and a user identifier from a frame and writes a transmission byte count on a user identifier basis and a destination address basis in a transmission byte count table T2. The transmission byte count table T2 stores the transmission byte count on a user basis and a destination basis.

A management unit 30 has two assignment destination control functions. The management unit 30 puts the information of each user in an assignment destination table T1 into a frame. The management unit 30 also totals the amounts of user traffic, detects any traffic imbalance among load distribution units 10-1 to 10-n, and corrects the information of a particular user in the assignment destination table T1 accordingly.

To be more specific, an overloaded-unit detection function totals the transmission byte counts of all the users and compares the transmission byte counts. If the maximum value exceeds the traffic reception capacity of the load distribution unit, the load distribution unit is determined to be overloaded. The traffic reception capacity is predetermined in the management unit.

An assignment adjustment function selects the user to be reassigned from the users having transmission traffic to the load distribution unit determined to be overloaded. The assignment destination table T1 is corrected so that the assignment to the load distribution unit of the selected user is reduced and reassigned to the load distribution unit with the least amount of transmission traffic.

The operation of the multi-user load distribution system 1a will next be desired in further detail. The difference from the load distribution system 1 described with reference to FIGS. 1 to 14 will be described.

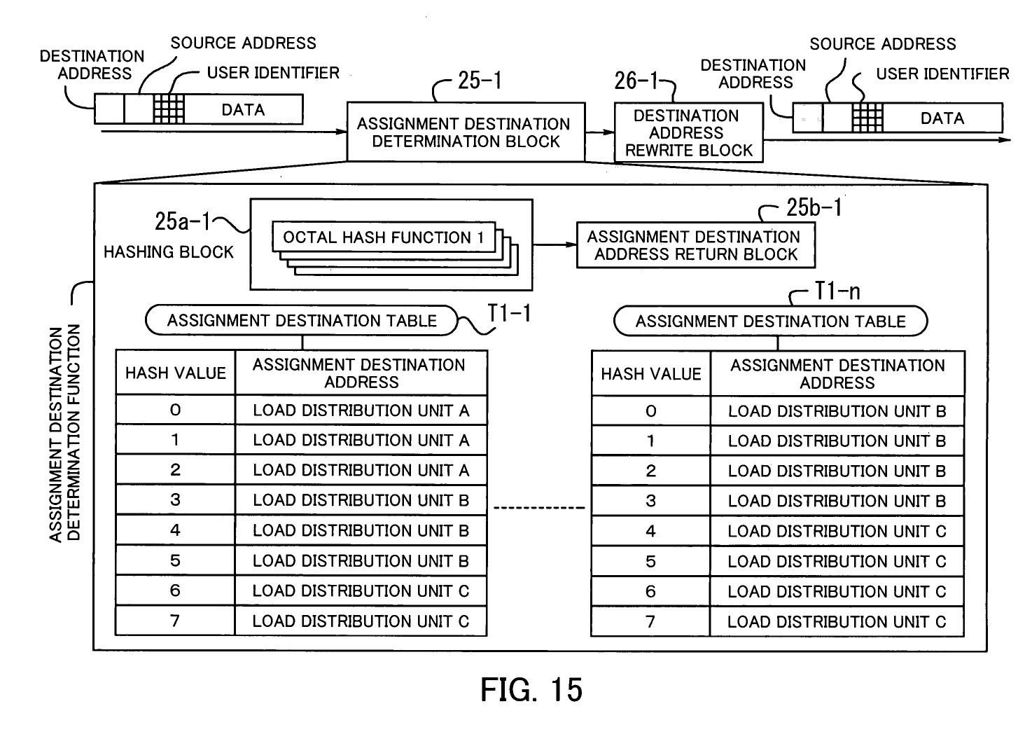

Determination of a frame assignment destination: FIG. 15 shows a separate assignment destination table T1 provided for each user. The individual users have independent assignment destination tables T1-1 to T1-n respectively.

An assignment destination determination block 25-1 receives a frame and extracts a user identifier and a source address from the frame. A hashing block 25a-1 inputs the source address to an octal hash function corresponding to the user identifier.

An assignment destination address return block 25b-1 transfers the address of the load distribution unit from the assignment destination table of the user corresponding to the hash value output from the hash function of the user, to a destination address rewrite block 26-1.

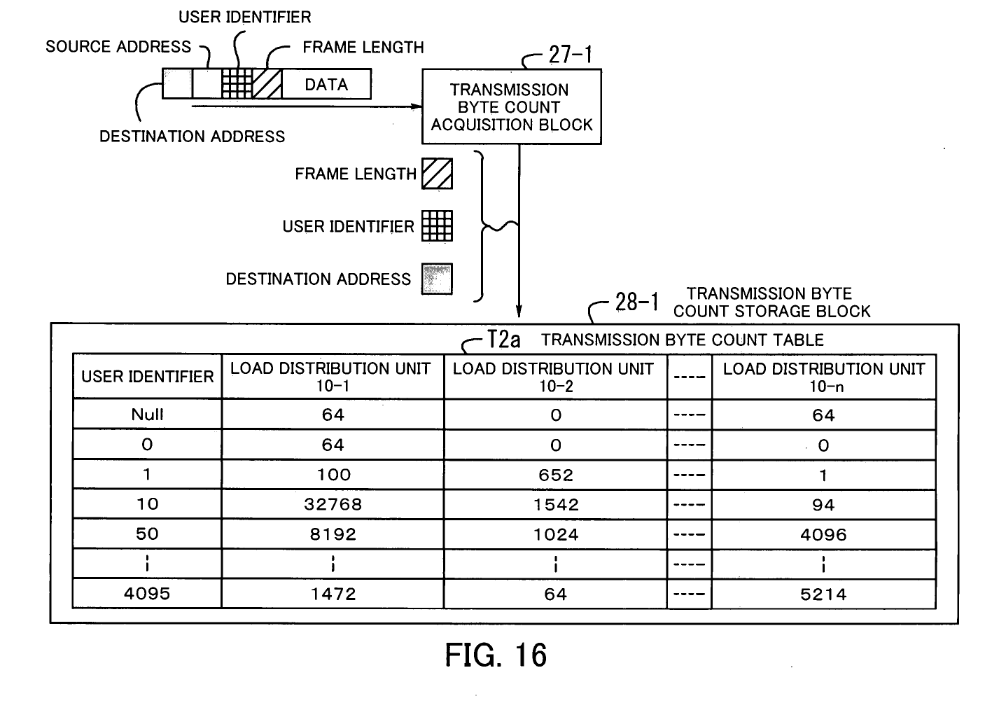

Transmission byte count measurement: FIG. 16 shows an overview of transmission byte count measurement. A transmission byte count acquisition block 27-1 receives the frame from the destination address rewrite block 26-1 and extracts a destination address, a frame length, and a user identifier from the frame. A transmission byte count storage block 28-1 adds the frame length to the item corresponding to the destination address of a transmission byte count table T2a corresponding to the user identifier. The figure shows that the transmission byte count of each user is stored for the load distribution units 10-1 to 10-n of the plurality of users (user identifiers).

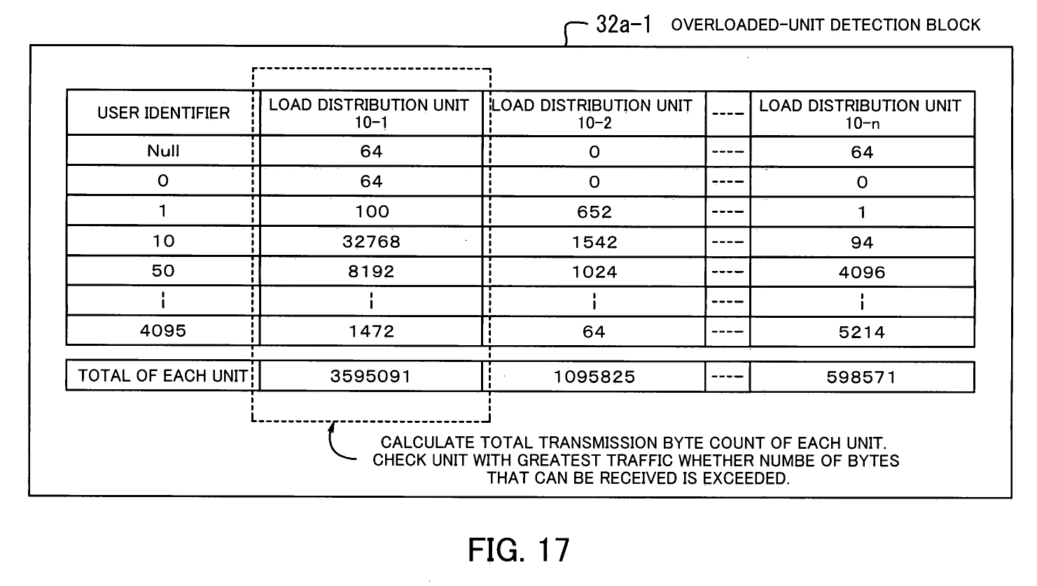

Determination of the contents of reassignment: FIG. 17 shows how the total number of transmission bytes of each load distribution unit is calculated. An overloaded-unit detection block 32a-1 receives a transmission byte count from a transmission byte count report block 29-1 and accumulates the count for each of the load distribution units 10-1 to 10-n.

The accumulated result is compared with a predetermined number of bytes that can be received by the load distribution unit. If the unit is determined to be overloaded, the information of the unit is transferred to an assignment adjustment block 32b-1.

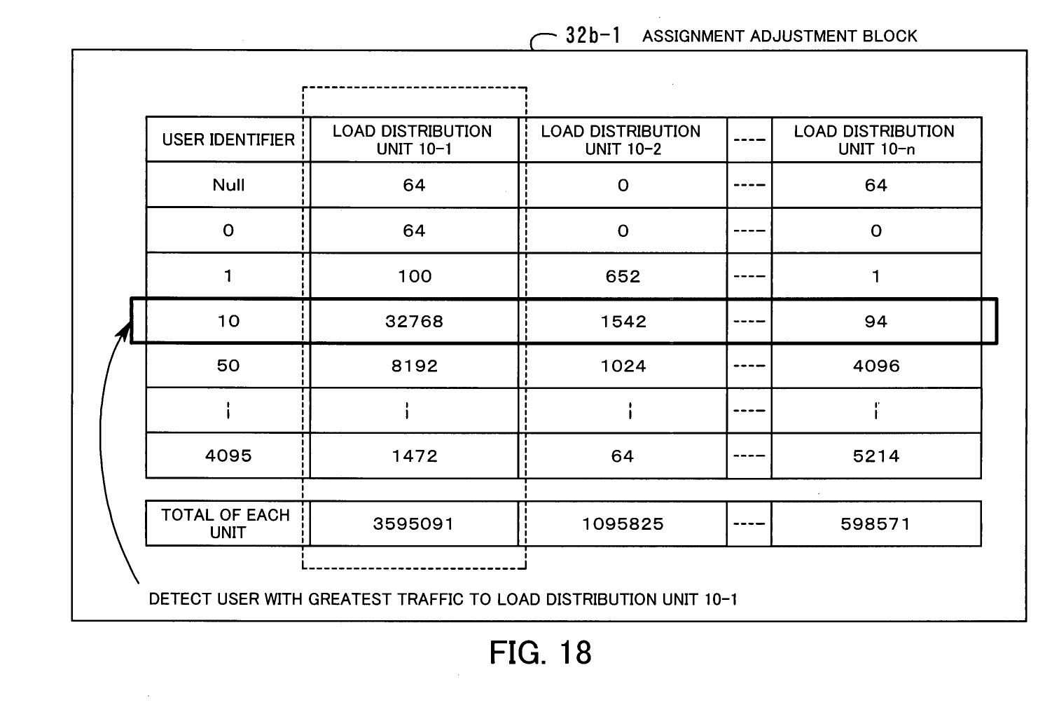

FIG. 18 shows an operation of detecting a user sending the greatest number of frames. The assignment adjustment block 32b-1 detects a user sending the greatest number of bytes to the load distribution unit determined to be overloaded, among the users sending frames to the unit (having non-zero transmission byte counts). In the figure, the load distribution unit 10-1 is overloaded, and the user of user identifier 10 has the greatest amount of traffic.

The user assignment to the load distribution unit determined to be overloaded is reduced, and the traffic assignment is adjusted. For instance, information of a reassignment to a unit with the smallest transmission byte count is generated.

Then, assignment processing in which the distribution granularity is improved by using a hash function with more hash values will be described. The distribution granularity (hereafter referred to as granularity) is the fineness of distribution ratio. If the granularity is N, load distribution can be performed in units of 1/N. If the granularity is 8, hash values 0 to 7 are provided. If the granularity is 16, hash values 0 to 15 are provided.

As a result of continued transmission byte count measurement in the load distribution system 1 or 1a, two load distribution units may be alternately assigned. If octal hashing is performed, the total traffic is divided into eight parts and those parts are individually assigned. In this case, the following sequence may be repeated: traffic assignment to the load distribution unit A in step n causes the load distribution unit A to be overloaded, and the traffic is reassigned to the load distribution unit B; traffic assignment to the load distribution unit B in step n+1 causes the load distribution unit B to be overloaded, and the traffic is reassigned to the load distribution unit A.

This problem is caused by a low granularity. If two load distribution units are alternately assigned, the granularity of the hash function is raised, such as from 8 values to 16 values or from 8 values to 32 values.

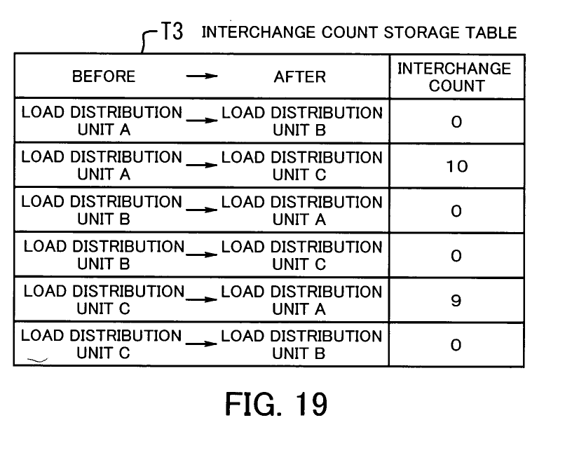

FIG. 19 shows an interchange count storage table. An interchange count storage table T3 is managed by the assignment adjustment block 32b. The assignment adjustment block 32b obtains a pair of alternately-assigned load distribution units and the number of interchanges from the determined contents of the assignment, and writes the information as an item in the interchange count storage table T3.

The interchange count storage table T3 is referenced after an appropriate period of time, such as one hour. The table is searched for any two items having a pair of identical load distribution units switched in opposite ways before and after a traffic assignment and non-zero interchange counts which are identical or differ by one.

In the figure, an interchange from the load distribution unit A to the load distribution unit C takes place ten times while an interchange from the load distribution unit C to the load distribution unit A takes place nine times. This indicates that the load distribution units A and C are alternately assigned. The assignment adjustment block 32b inserts an instruction to increase the granularity of the hash function into a control frame and sends the control frame to the pre-assignment unit 20. The function to adjust the granularity of the hash function is applied to both the load distribution system 1 and the load distribution system 1a.

The processing of discarding frames will next be described. When the management unit 30 changes the assignment destination with regard to the processing performed by the load distribution system 1 or 1a, the corresponding frame may be discarded instead of assigning another load distribution unit.

An actual operation will be described as an example. Suppose that the overloaded-unit detection block 32a determines the load distribution unit A to be overloaded and that the load distribution units B and C handle the maximum number of reception bytes. If the traffic of the load distribution unit A is reassigned to the load distribution unit B or C, the load distribution unit B or C becomes overloaded.

In that case, the assignment adjustment block 32b specifies in the assignment destination table T1 that the frame assigned to the load distribution unit A is discarded. The discarding of frames may also be specified immediately when a load distribution unit is determined to be overloaded. The transmission byte count measurement function of the pre-assignment unit 20 does not count the number of bytes of the frame specified to be discarded and transfers the frame to the output port determination block 22. The transmission byte count table T2 may include a counter for counting the number of discarded frames, and the frame may be transferred to the output port determination block 22 after the number of bytes is counted.

The output port determination block 22 discards the frame specified to be discarded without transferring it to anywhere. Actually, the frame is not output but overwritten by a new frame. The processing of discarding frames is applied to both the load distribution system 1 and the load distribution system 1a.

As described above, according to the present invention, an imbalance in traffic assignment can be eliminated while the high speed is maintained, so that the destination unit can prevent a frame overflow from occurring. Balanced traffic assignment is implemented at a high speed in a multi-user environment, so that interference among multiple users can be avoided while the high speed is maintained.

A load distribution system according to the present invention has the pre-assignment unit for measuring the number of transmission bytes of an input frame and the management unit for comparing the transmission byte count with the number of bytes that can be received by the load distribution unit, detecting any overloaded load distribution unit, and adjusting the amount of traffic assigned to the load distribution unit. This configuration makes it possible to measure load and perform load distribution control efficiently at a high speed, so that the quality of communication and reliability can be improved.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A load distribution system for distributing traffic load, comprising:
a plurality of load distribution units for receiving a traffic assignment and performing load distribution;
a pre-assignment unit disposed in a stage preceding the plurality of load distribution units, the pre-assignment unit comprising:
a transmission byte count acquisition block for acquiring the number of transmission bytes from a frame,
a transmission byte count storage block for storing the number of transmission bytes accumulated on a destination address basis in a transmission byte count table, and
a transmission byte count report block for reporting the number of transmission bytes stored in the transmission byte count table, at regular intervals; and
a management unit comprising:
an overloaded-unit detection block for detecting any overloaded load distribution unit by comparing the reported number of transmission bytes and the number of transmission bytes that can be received by each of the plurality of load distribution units and
an assignment adjustment block for adjusting the traffic assignment by reducing the volume of an assignment to any load distribution unit determined to be overloaded.

2. The load distribution system according to claim 1, wherein the pre-assignment unit further comprising:
an assignment destination table for assigning a load distribution unit in accordance with a hash value;
a table write block for writing the contents of a traffic assignment sent from the management unit in the assignment destination table;
an assignment destination determination block for determining an assignment destination address by applying a hash function to the source address of an input frame, obtaining a hash value, and searching through the assignment destination table for the address of a load distribution unit corresponding to the hash value; and
a destination address rewrite block for rewriting the destination address of the input frame to the assignment destination address and transferring the frame with the rewritten destination address to the transmission byte count acquisition block.

3. The load distribution system according to claim 1, wherein the assignment adjustment block manages the number of interchanges between a pair of load distribution units before and after a traffic assignment, and increases the distribution granularity of the hash function if two items are found to have an identical pair of load distribution units switched in opposite ways and have non-zero interchange counts which are identical or differ by one.

4. The load distribution system according to claim 1, wherein the assignment adjustment block specifies the discarding of a frame assigned to a load distribution unit determined to be overloaded.

5. The load distribution system according to claim 1, wherein the assignment adjustment block specifies the discarding of a frame assigned to a first load distribution unit determined to be overloaded if a second load distribution unit with the smallest transmission byte count is nearly overloaded when a reassignment from the first load distribution unit to the second load distribution unit is going to take place.

6. A pre-assignment unit for assigning traffic in a stage preceding load distribution units, the pre-assignment unit comprising:
a transmission byte count acquisition block for acquiring the number of transmission bytes from a frame;
a transmission byte count storage block for storing the number of transmission bytes accumulated on a destination address basis in a transmission byte count table; and
a transmission byte count report block for reporting the number of transmission bytes stored in the transmission byte count table, at regular intervals.

7. The pre-assignment unit according to claim 6, further comprising:
an assignment destination table for assigning a load distribution unit in accordance with a hash value;
a table write block for writing the contents of a traffic assignment sent from a management unit in the assignment destination table;
an assignment destination determination block for determining an assignment destination address by applying a hash function to the source address of an input frame, obtaining a hash value, and searching through the assignment destination table for the address of a load distribution unit corresponding to the hash value; and
a destination address rewrite block for rewriting the destination address of the input frame to the assignment destination address and transferring the frame with the rewritten destination address to the transmission byte count acquisition block.

8. A management unit for performing traffic assignment control, comprising:
an overloaded-unit detection block for detecting any overloaded load distribution unit by comparing a measured transmission byte count and the number of transmission bytes that can be received by the load distribution unit; and
an assignment adjustment block for adjusting the traffic assignment by reducing the volume of assignment to any load distribution unit determined to be overloaded.

9. The management unit according to claim 8, wherein the assignment adjustment block manages the number of interchanges between a pair of load distribution units before and after a traffic assignment, and increases the distribution granularity of a hash function if two items are found to have an identical pair of load distribution units switched in opposite ways and have non-zero interchange counts which are identical or differ by one.

10. The management unit according to claim 8, wherein the assignment adjustment block specifies the discarding of a frame assigned to a load distribution unit determined to be overloaded.

11. The management unit according to claim 8, wherein the assignment adjustment block specifies the discarding of a frame assigned to a first load distribution unit determined to be overloaded if a second load distribution unit with the smallest transmission byte count is nearly overloaded when a reassignment from the first load distribution unit to the second load distribution unit is going to take place.

12. A load distribution system for distributing traffic load, comprising:
a plurality of load distribution units for receiving a traffic assignment and performing load distribution;
a pre-assignment unit disposed in a stage preceding the plurality of load distribution units, the pre-assignment unit comprising:
a transmission byte count acquisition block for acquiring the number of transmission bytes from a frame,
a transmission byte count storage block for storing the number of transmission bytes accumulated on a destination address basis about individual users in a transmission byte count table, and
a transmission byte count report block for reporting the number of transmission bytes stored in the transmission byte count table, at regular intervals; and
a management unit comprising:
an overloaded-unit detection block for detecting any overloaded load distribution unit by comparing the reported number of transmission bytes accumulated on a load distribution unit basis and the number of transmission bytes that can be received by each of the plurality of load distribution units and
an assignment adjustment block for adjusting the traffic assignment by detecting a user with the greatest amount of traffic to any load distribution unit determined to be overloaded and reducing the volume of an assignment to the user.

13. The load distribution system according to claim 12, wherein the pre-assignment unit further comprising:
a user-based assignment destination table for assigning a load distribution unit in accordance with a hash value;
a table write block for writing the contents of a traffic assignment sent from the management unit in the assignment destination table;
an assignment destination determination block for determining an assignment destination address by applying a hash function to the source address of an input frame, obtaining a hash value, and searching through the assignment destination table for the address of a load distribution unit corresponding to the hash value; and
a destination address rewrite block for rewriting the destination address of the input frame to the assignment destination address and transferring the frame with the rewritten destination address to the transmission byte count acquisition block.

14. The load distribution system according to claim 12, wherein the assignment adjustment block manages the number of interchanges between a pair of load distribution units before and after a traffic assignment, and increases the distribution granularity of the hash function if two items are found to have an identical pair of load distribution units switched in opposite ways and have non-zero interchange counts which are identical or differ by one.

15. The load distribution system according to claim 12, wherein the assignment adjustment block specifies the discarding of a frame assigned to a load distribution unit determined to be overloaded.

16. The load distribution system according to claim 12, wherein the assignment adjustment block specifies the discarding of a frame assigned to a first load distribution unit determined to be overloaded if a second load distribution unit with the smallest transmission byte count is nearly overloaded when a reassignment from the first load distribution unit to the second load distribution unit is going to take place.

17. A pre-assignment unit for assigning traffic in a stage preceding load distribution units, the pre-assignment unit comprising:
a transmission byte count acquisition block for acquiring the number of transmission bytes from a frame;
a transmission byte count storage block for storing the number of transmission bytes accumulated on a destination address basis about individual users in a transmission byte count table; and
a transmission byte count report block for reporting the number of transmission bytes stored in the transmission byte count table, at regular intervals.

18. The pre-assignment unit according to claim 17, further comprising:
a user-based assignment destination table for assigning a load distribution unit in accordance with a hash value;
a table write block for writing the contents of a traffic assignment sent from a management unit in the assignment destination table;
an assignment destination determination block for determining an assignment destination address by applying a hash function to the source address of an input frame, obtaining a hash value, and searching through the assignment destination table for the address of a load distribution unit corresponding to the hash value; and
a destination address rewrite block for rewriting the destination address of the input frame to the assignment destination address and transferring the frame with the rewritten destination address to the transmission byte count acquisition block.

19. A management unit for performing traffic assignment control, comprising:
an overloaded-unit detection block for detecting any overloaded load distribution unit by comparing a measured transmission byte count accumulated on a load distribution unit basis and the number of transmission bytes that can be received by a load distribution unit; and
an assignment adjustment block for adjusting the traffic assignment by detecting a user with the greatest amount of traffic to any load distribution unit determined to be overloaded and reducing the volume of an assignment to the user.

20. The management unit according to claim 19, wherein the assignment adjustment block manages the number of interchanges between a pair of load distribution units before and after a traffic assignment, and increases the distribution granularity of a hash function if two items are found to have an identical pair of load distribution units switched in opposite ways and have non-zero interchange counts which are identical or differ by one.

21. The management unit according to claim 19, wherein the assignment adjustment block specifies the discarding of a frame assigned to a load distribution unit determined to be overloaded.

22. The management unit according to claim 19, wherein the assignment adjustment block specifies the discarding of a frame assigned to a first load distribution unit determined to be overloaded if a second load distribution unit with the smallest transmission byte count is nearly overloaded when a reassignment from the first load distribution unit to the second load distribution unit is going to take place.

23. A load distribution method for distributing traffic load, comprising the steps of:
acquiring the number of transmission bytes from a frame;
storing the number of transmission bytes accumulated on a destination address basis in a transmission byte count table;
reporting the number of transmission bytes stored in the transmission byte count table, at regular intervals;
detecting any overloaded load distribution unit by comparing the reported number of transmission bytes and the number of transmission bytes that can be received by a load distribution unit; and
adjusting the traffic assignment by reducing the volume of an assignment to any load distribution unit determined to be overloaded.

24. The load distribution method according to claim 23, wherein, when there is a plurality of users, the number of transmission bytes accumulated on a destination address basis is stored on a user basis in the transmission byte count table; any overloaded load distribution unit is detected by comparing an informed transmission byte count accumulated on a load distribution unit basis and the number of transmission bytes that can be received by the load distribution unit; and the traffic assignment is adjusted by detecting a user with the greatest amount of traffic to any load distribution unit determined to be overloaded and reducing the volume of an assignment to the user.

25. The load distribution method according to claim 23, wherein the number of interchanges between a pair of load distribution units before and after a traffic assignment is managed; and if two items have an identical pair of load distribution units switched in opposite ways and have non-zero interchange counts which are identical or differ by one, the distribution granularity of a hash function is increased.

26. The load distribution method according to claim 23, wherein the discarding of a frame assigned to a load distribution unit determined to be overloaded is specified.

27. The load distribution method according to claim 23, wherein the discarding of a frame assigned to a first load distribution unit determined to be overloaded is specified if a second load distribution unit with the smallest transmission byte count is nearly overloaded when a reassignment from the first load distribution unit to the second load distribution unit is going to take place.
